(19) United States
(12) Patent Application Publication
(10) Pub. No.: US 2007/0022082 A1
(43) Pub. Date: Jan. 25, 2007

(54) Search engine coverage

(75) Inventors: Alain Charles Azagury, Haifa (IL); Carsten Leue, Sindelfingen (DE); Uri Schonfeld, Nesher (IL)

Correspondence Address: Stephen C. Kaufman;IBM CORPORATION, Intellectual Property Law Dept., P.O. Box 218, Yorktown Heights, NY, 10598, US

(73) Assignee: International Business Machines Corporation, Armonk, NY (US)

(21) Appl. No.: 11/185,999

(22) Filed: Jul. 20, 2005

(51) Int. Cl. G06F 17/30

(52) U.S. Cl. 707/1

(57) ABSTRACT

A method for improved search engine coverage, the method including receiving at least one computer-network based document at a first computer, storing any of a link and content associated with the document in a cache, providing the cached information to either of a traversal application and a search engine, and causing the retrieval of the document via either of the traversal application and the search engine using the cached information.

### FIELD OF THE INVENTION

The present invention relates to computer-network based document search engines in general, and more particularly to improved search engine coverage of documents not normally reachable by link traversal from document to document.

### BACKGROUND OF THE INVENTION

Computer networks, such as the Internet, provide computer users with access to a vast and ever-increasing number of network-based documents, such as web pages. One software tool that computer users use to seek out documents is the search engine, which maintains an index of network-based documents and their addresses, typically expressed as Universal Resource Locators (URLs) or links. Search engines typically employ traversal applications, such as web crawlers, spiders, and robots, to locate network-based documents by traversing hypertext links from document to document and recording documents/links encountered during traversal. The links, and often the document content itself, are then added to the search engine index. Unfortunately, such traversal applications typically traverse only a small fraction of network-based documents in this manner, as many documents are not linked to other documents. Accordingly, search engine coverage is often limited.

### SUMMARY OF THE INVENTION

The present invention discloses a system and method for improved search engine coverage, including documents not normally reachable by hypertext link traversal from document to document, whereby network-based documents and/or their links that are stored in a computer user's cache, a proxy cache, or other server cache, are provided to a search engine traversal application and/or added directly to a search engine index. In this manner a search engine index may include documents/links identified by their links to/from other documents, as well as documents/links that are not linked to other documents or that were accessed by users, proxies, or servers but that are not yet included in the search engine index.

In one aspect of the present invention a method is provided for improved search engine coverage, the method including receiving at least one computer-network based document at a first computer, storing any of a link and content associated with the document in a cache, providing the cached information to either of a traversal application and a search engine, and causing the retrieval of the document via either of the traversal application and the search engine using the cached information.

In another aspect of the present invention the receiving step includes receiving where the document is not linked to other documents.

In another aspect of the present invention the method further includes compiling statistical information relating to the cached information.

In another aspect of the present invention the method further includes providing the statistical information to either of the traversal application and the search engine.

In another aspect of the present invention the storing step includes identifying any links associated with the document, and normalizing any of the links.

In another aspect of the present invention the providing step includes providing any of the normalized links to either of the traversal application and the search engine.

In another aspect of the present invention the method further includes replacing any of the links in the document with any of the normalized links.

In another aspect of the present invention a method is provided for improved search engine coverage, the method including identifying any links associated with a computer-network based document, normalizing any of the links, providing any of the normalized links to either of a traversal application and a search engine, and causing the retrieval of the document via either of the traversal application and the search engine using any of the normalized links.

In another aspect of the present invention the method further includes replacing any of the links in the document with any of the normalized links.

In another aspect of the present invention the method further includes receiving a request from a requestor for the document, and providing the document with the normalized links to the requester.

In another aspect of the present invention a system is provided for improved search engine coverage, the system including means for receiving at least one computer-network based document at a first computer, means for storing any of a link and content associated with the document in a cache, means for providing the cached information to either of a traversal application and a search engine, and means for causing the retrieval of the document via either of the traversal application and the search engine using the cached information.

In another aspect of the present invention the means for receiving is operative to receive where the document is not linked to other documents.

In another aspect of the present invention the system further includes means for compiling statistical information relating to the cached information.

In another aspect of the present invention the system further includes means for providing the statistical information to either of the traversal application and the search engine.

In another aspect of the present invention the means for storing is operative to identify any links associated with the document, and normalize any of the links.

In another aspect of the present invention the means for providing is operative to provide any of the normalized links to either of the traversal application and the search engine.

In another aspect of the present invention the system further includes means for replacing any of the links in the document with any of the normalized links.

In another aspect of the present invention a system is provided for improved search engine coverage, the system including means for identifying any links associated with a computer-network based document, means for normalizing any of the links, means for providing any of the normalized links to either of a traversal application and a search engine, and means for causing the retrieval of the document via either of the traversal application and the search engine using any of the normalized links.

In another aspect of the present invention the system further includes means for replacing any of the links in the document with any of the normalized links.

In another aspect of the present invention the system further includes means for receiving a request from a requestor for the document, and means for providing the document with the normalized links to the requestor.

In another aspect of the present invention a computer-implemented program is provided embodied on a computer-readable medium, the computer program including a first code segment operative to receive at least one computer-network based document at a first computer, a second code segment operative to store any of a link and content associated with the document in a cache, a third code segment operative to provide the cached information to either of a traversal application and a search engine, and a fourth code segment operative to cause the retrieval of the document via either of the traversal application and the search engine using the cached information.

It is appreciated throughout the specification and claims that the term “document” may be understood as including any type of computer file that is accessible via a computer network, such as, but not limited to, web pages, word processing files, and multimedia files.

It is further appreciated throughout the specification and claims that the term “link” may be understood as including any type of indicator of the location or address of a document that is accessible via a computer network, such as, but not limited to, IP addresses and URLs.

It is further appreciated throughout the specification and claims that the term “cache” may be understood as including any mechanism for recording the contents of retrieved documents and/or their links.

It is further appreciated throughout the specification and claims that the term “traversal application” may be understood as including as any application, including web crawlers, spiders, and robots, that locates documents by following hypertext links from document to document.

### BRIEF DESCRIPTION OF THE DRAWINGS

The present invention will be understood and appreciated more fully from the following detailed description taken in conjunction with the appended drawings in which:

FIGS. 1A and 1B are simplified pictorial illustrations of a system with improved search engine coverage, constructed and operative in accordance with a preferred embodiment of the present invention;

FIG. 1C is a simplified flowchart illustration of an exemplary method of operation of the system of FIGS. 1A and 1B, operative in accordance with a preferred embodiment of the present invention;

FIG. 2A is a simplified pictorial illustration of a system for link normalization, constructed and operative in accordance with a preferred embodiment of the present invention; and

FIG. 2B is a simplified flowchart illustration of an exemplary method of operation of the system of FIG. 2A, operative in accordance with a preferred embodiment of the present invention.

### DETAILED DESCRIPTION OF PREFERRED EMBODIMENTS

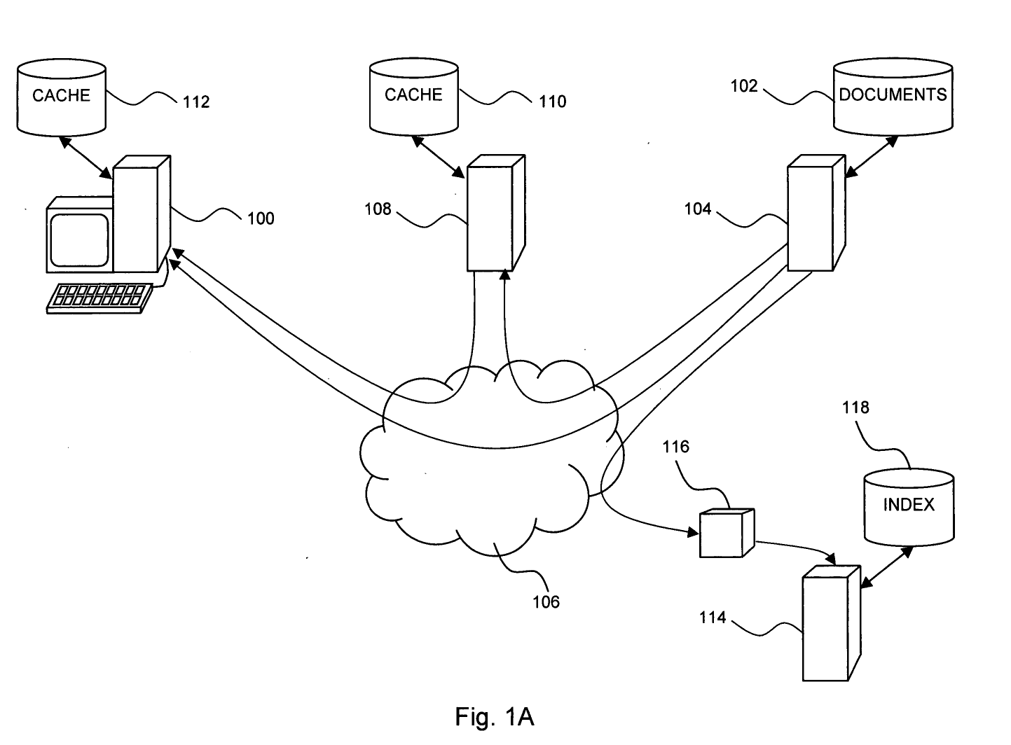

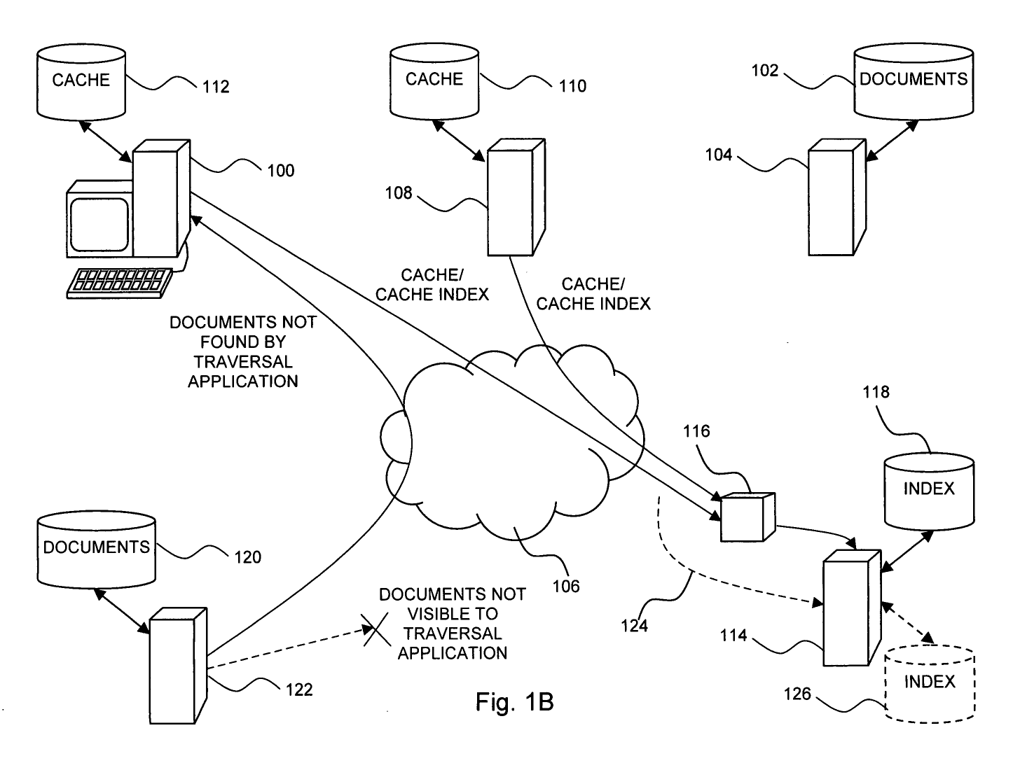

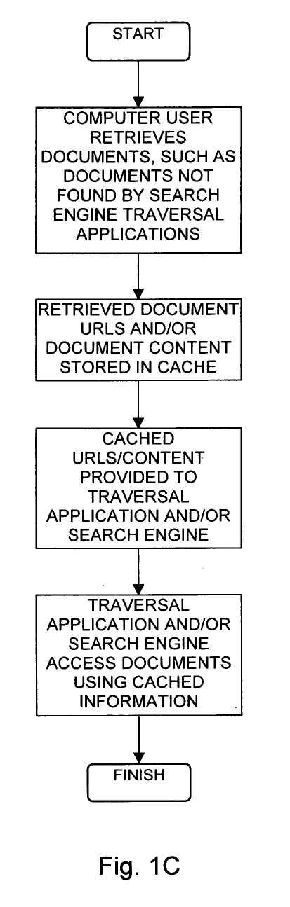

Reference is now made to FIGS. 1A and 1B, which are simplified pictorial illustrations of a system with improved search engine coverage, constructed and operative in accordance with a preferred embodiment of the present invention, and to FIG. 1C, which is a simplified flowchart illustration of an exemplary method of operation of the system of FIGS. 1A and 1B, operative in accordance with a preferred embodiment of the present invention. Referring specifically to FIG. 1A, a computer user at a computer 100 retrieves documents 102 directly from a server 104 via a network 106, such as the Internet. Documents 102 may be static documents with set content, or may be dynamically generated in accordance with conventional techniques. Additionally or alternatively, computer 100 may be used to retrieve documents 102 from a proxy server 108 where copies of documents 102 may be stored in a cache 110. Computer 100 may then store the links of retrieved documents 102 and/or some or all of the content of documents 102 in a cache 112.

A search engine 114 uses a traversal application 116 employing conventional document traversal techniques to identify documents 102 and documents from other servers (not shown) by following hypertext links from document to document. Search engine 114 typically constructs an index 118 of the links and the content of the traversed documents. Using conventional techniques, search engine 114 searches index 118 in response to user queries and provides users with links of indexed documents.

Referring now to FIG. 1B, computer 100 may be used to retrieve documents 120 from a server 122, particularly documents not found or capable of being found using document traversal techniques, such as documents that are not linked to other documents. Such documents are typically accessed by computer 100 through a priori knowledge of the document address or via a private Intranet not directly accessible to other computers via network 106. As before, computer 100 may then store the links of retrieved documents 120 and/or some or all of the content of documents 120 in cache 112. Similarly, the links of documents 120 and/or some or all of the content of documents 120 may be stored by proxy server 108 in cache 110. The links and/or content stored in cache 112 may be provided by computer 100 to traversal application 116, as may proxy server 108 provide such information from cache 110 to traversal application 116, which may then access documents 120 and provide the link and/or content information relating to documents 120 to search engine 114. Additionally or alternatively, the information from cache 110/112 may be provided directly to search engine 114, as indicated by a dashed arrow 124. Search engine 114 may use this information to augment index 118, or may construct a separate index 126 from the information in index 118 as well as the information received regarding documents 120. Search engine 114 may then replace index 118 with index 126 at a later time, using index 126 to service user queries. Additionally or alternatively, the information from cache 110/112 may be indexed by computer 100/proxy server 108, with only the index being provided to search engine 114.

It will be appreciated that information may be conveyed from computer 100/proxy server 108 to traversal application 116/search engine 114 using any known technique, such as push or pull. Computer 100/proxy server 108 may also collect statistics using any known technique relating to what is stored in their cache, such as how often a document was accessed, when a document was accessed, how long since the last access, etc. Such statistical information may be conveyed to traversal application 116/search engine 114 as well. Computer 100/proxy server 108 may also determine, in accordance with predefined criteria, that not all information stored in their cache should be conveyed to traversal application 116/search engine 114. For example, computer 100/proxy server 108 may decide not to report cached items to traversal application 116/search engine 114 that have not been accessed for a predefined time period, such as one month.

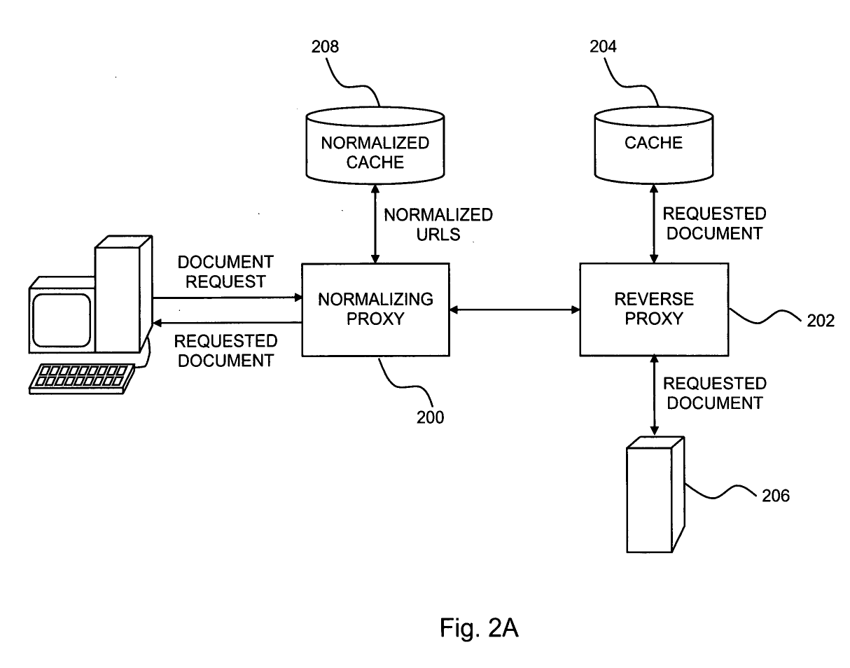

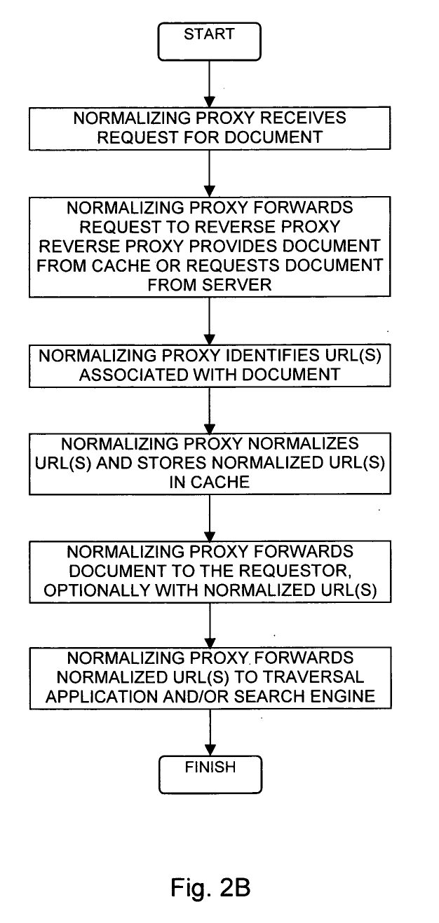

Reference is now made to FIG. 2A, which is a simplified pictorial illustration of a system for link normalization, constructed and operative in accordance with a preferred embodiment of the present invention, and to FIG. 2B, which is a simplified flowchart illustration of an exemplary method of operation of the system of FIG. 2A, operative in accordance with a preferred embodiment of the present invention. The system of FIG. 2A may be implemented in conjunction with the system of FIGS. 1A and 1B where multiple links point to the same document, and/or where links include user-specific, session-specific, or other information that is not to be provided to a search engine, such as in a web portal environment where the link contains user-specific context information. Referring specifically to FIG. 2A, a normalizing proxy 200 is provided for intercepting or directly receiving requests for documents. Proxy 200 then forwards the request, such as to a reverse proxy 202, which then either satisfies the request from a cache 204 or requests the document from a server 206. The requested document is then provided to proxy 200, typically together with cache header information. Proxy 200 examines the returned document, identifies the link of the document and/or of any links found in the document, and stores a normalized version of any of the identified links in a cache 208. Proxy 200 then forwards the document to the requester, either in the form in which proxy 200 received the document, or with the document's non-normalized links replaced with normalized links.

Proxy 200 may be implemented as part of the document generation infrastructure, such as part of a web portal, where proxy 200 generates normalized links directly when serving a document instead of normalizing links that have been embedded within documents received by proxy 200.

Proxy 200 preferably normalizes links in accordance with predefined normalization criteria. Such criteria may include deriving a canonical link from a non-canonical link in accordance with conventional techniques, and/or stripping the link of predefined information, such as user-specific or session-specific information. Proxy 200 may also maintain a mapping of non-normalized links from which the same normalized link is derived, and may also collect statistics using any known technique for non-normalized links which map to the same normalized link. The normalized links stored in cache 208 and/or any collected statistics may be provided by proxy 200 to traversal application 116 and/or search engine 114 as described above with reference to FIG. 1B. Traversal application 116 may then retrieve a document using a normalized link. Where proxy 200 provides a document to traversal application 116 containing normalized links, these too may be traversed.

It is appreciated that one or more of the steps of any of the methods described herein may be omitted or carried out in a different order than that shown, without departing from the true spirit and scope of the invention.

While the methods and apparatus disclosed herein may or may not have been described with reference to specific computer hardware or software, it is appreciated that the methods and apparatus described herein may be readily implemented in computer hardware or software using conventional techniques.

While the present invention has been described with reference to one or more specific embodiments, the description is intended to be illustrative of the invention as a whole and is not to be construed as limiting the invention to the embodiments shown. It is appreciated that various modifications may occur to those skilled in the art that, while not specifically shown herein, are nevertheless within the true spirit and scope of the invention.

What is claimed is:

1. A method for improved search engine coverage, the method comprising:
receiving at least one computer-network based document at a first computer;
storing any of a link and content associated with said document in a cache;
providing said cached information to either of a traversal application and a search engine; and
causing the retrieval of said document via either of said traversal application and said search engine using said cached information.

2. A method according to claim 1 wherein said receiving step comprises receiving where said document is not linked to other documents.

3. A method according to claim 1 and further comprising compiling statistical information relating to said cached information.

4. A method according to claim 3 and further comprising providing said statistical information to either of said traversal application and said search engine.

5. A method according to claim 1 wherein said storing step comprises:
identifying any links associated with said document; and
normalizing any of said links.

6. A method according to claim 5 wherein said providing step comprises providing any of said normalized links to either of said traversal application and said search engine.

7. A method according to claim 5 and further comprising replacing any of said links in said document with any of said normalized links.

8. A method for improved search engine coverage, the method comprising:
identifying any links associated with a computer-network based document;
normalizing any of said links;
providing any of said normalized links to either of a traversal application and a search engine; and
causing the retrieval of said document via either of said traversal application and said search engine using any of said normalized links.

9. A method according to claim 8 and further comprising replacing any of said links in said document with any of said normalized links.

10. A method according to claim 9 and further comprising:
receiving a request from a requester for said document; and
providing said document with said normalized links to said requestor.

11. A system for improved search engine coverage, the system comprising:
means for receiving at least one computer-network based document at a first computer;
means for storing any of a link and content associated with said document in a cache;
means for providing said cached information to either of a traversal application and a search engine; and
means for causing the retrieval of said document via either of said traversal application and said search engine using said cached information.

12. A system according to claim 11 wherein said means for receiving is operative to receive where said document is not linked to other documents.

13. A system according to claim 11 and further comprising means for compiling statistical information relating to said cached information.

14. A system according to claim 13 and further comprising means for providing said statistical information to either of said traversal application and said search engine.

15. A system according to claim 11 wherein said means for storing is operative to:
identify any links associated with said document; and
normalize any of said links.

16. A system according to claim 15 and further comprising means for replacing any of said links in said document with any of said normalized links.

17. A system for improved search engine coverage, the system comprising:
means for identifying any links associated with a computer-network based document;
means for normalizing any of said links;
means for providing any of said normalized links to either of a traversal application and a search engine; and
means for causing the retrieval of said document via either of said traversal application and said search engine using any of said normalized links.

18. A system according to claim 17 and further comprising means for replacing any of said links in said document with any of said normalized links.

19. A system according to claim 18 and further comprising:
means for receiving a request from a requestor for said document; and
means for providing said document with said normalized links to said requestor.

20. A computer-implemented program embodied on a computer-readable medium, the computer program comprising:
a first code segment operative to receive at least one computer-network based document at a first computer;
a second code segment operative to store any of a link and content associated with said document in a cache;
a third code segment operative to provide said cached information to either of a traversal application and a search engine; and
a fourth code segment operative to cause the retrieval of said document via either of said traversal application and said search engine using said cached information.
